(19) United States
(12) Patent Application Publication
(10) Pub. No.: US 2012/0029822 A1
(43) Pub. Date: Feb. 2, 2012

(54) METHOD FOR OPERATING AN INFORMATION SYSTEM, INFORMATION SYSTEM, AND MEMORY MEDIUM

(75) Inventor: Ernst-Peter Neuekirchner, Hildesheim (DE)

(73) Assignee: Robert Bosch GmbH, Stuttgart (DE)

(21) Appl. No.: 13/138,398

(22) PCT Filed: Feb. 9, 2010
(86) PCT No.: PCT/EP2010/051581

§ 371 Date: Oct. 18, 2011

(30) Foreign Application Priority Data
Feb. 23, 2009 (DE) 10 2009 001 068.8

(51) Int. Cl. G01C 21/26

(52) U.S. Cl. 701/532

(57) ABSTRACT

A navigation system for a motor vehicle configured to output information via an output unit has a memory and a computing unit, map data being provided with map elements, and attributes for the map data being provided, the attributes representing properties of map elements. The map data include edges and coordinate points, the coordinate points defining a geographical position of the edges, and intermediate points which define geographical points of the edges being stored, the intermediate points defining sections of the edges in which an attribute is valid for the edge. The computing unit ascertains at least one information item on the basis of the edges, the coordinate points, the intermediate points, and the attributes, and outputs the information item, and at least a portion of the intermediate points is stored in a different memory area than the coordinate points.

### BACKGROUND OF THE INVENTION

1. Field of the Invention

The present invention relates to a method for operating an information system, in particular a navigation system for a motor vehicle, and an information system and a memory medium.

2. Description of Related Art

Information systems, for example navigation systems, use digital maps having map data for representing a map section on a display for route description and route determination, for destination entry, destination finding, and destination guiding of a vehicle, for example a motor vehicle, steered by a driver. The digital maps are possibly stored on CDs or DVDs, where they are subdivided into individual partitions according to area so that the data to be loaded into the memory may be limited with regard to the data volume. The data volume influences the required size of the memory, as well as the data loading speed or the data processing speed. As the result of partitioning the map data, from the total quantity of map data, data may be selected from some partitions in order to select a meaningful area for one or several applications such as position finding or route computation.

Digital map data are used as map data; for example, roadways are illustrated as so-called edges using the map data, and intersection points, junctions, or the course of the edges are illustrated with the aid of coordinate points. The coordinate points are also referred to as nodes. The actual course of the roadway is approximated by the edges and coordinate points, the edges being described, for example, by a consecutive sequence of linear edge sections. Roadway systems are thus illustrated with the aid of directional graphs having edges and coordinate points. In addition to linear edges and punctiform coordinate points, digital maps also use surface elements or three-dimensional elements for imaging the actual circumstances. The characteristics of the edges and of the surface elements are described by attributes which are stored together with the map elements. Thus, the data volume for describing a map element or the entirety of the map elements increases considerably with increasing detail of the content of the digital map, and thus, with increasing number of attributes.

### BRIEF SUMMARY OF THE INVENTION

An object of the present invention is to provide a method for operating an information system, in particular a navigation system for a motor vehicle, an information system, and a memory medium, using which it is possible to quickly and reliably ascertain information based on the map data.

According to the present invention, the object is achieved by a method, an information system, and a memory medium, in that at least a portion of the intermediate points is stored in a different data unit, in particular in a different memory area, of the memory than the coordinate points. The intermediate points define geographical points of the maps, the intermediate points designating sections of the edges in which an attribute is valid for the edge. On the basis of the edges, the coordinate points, and the attributes, the information system then ascertains at least one information item, which is output.

Thus, depending on the information to be ascertained, it is not necessary to also access the data unit of the intermediate points, to input the data, and to take the information into account in the ascertainment. Therefore, less data needs to be read and processed. Overall, a more rapid and reliable method is achieved in this way. In particular, the working memory of the computing unit into which the data to be processed are input may be provided with a smaller design. The information system as a whole is therefore more cost-effective. Furthermore, the basic functioning of the information system is not impaired if a data unit of the intermediate points is damaged. The only tasks of the computing unit which are impaired are those which must access the data unit of the intermediate points.

In another specific embodiment, in ascertaining information, the computing unit accesses a first data unit in which coordinate points and/or map data and/or intermediate points are stored. However, the computing unit does not access a second data unit, in particular does not access a second memory area, in which intermediate points are stored when the intermediate points are not necessary for ascertaining the required information. The desired information is ascertained more quickly in this way.

In another specific embodiment, the map data and the attributes are at least partially stored in various data units, in particular in various memory areas. For example, the attributes may be subdivided into groups, for each group a particular data unit, in particular an independent memory area, being used for the storage. A data structure is thus provided which increases the data processing speed. For example, only those data units and/or memory areas are accessed whose attributes are actually needed for computing the information.

In another specific embodiment, difference values are associated with the intermediate points which define the position of the individual intermediate point in relation to another intermediate point or coordinate point. Thus, it is not necessary to store absolute position values for the intermediate points. In addition, using difference values for the position of the intermediate points allows more rapid and reliable processing of the intermediate points.

### BRIEF DESCRIPTION OF THE DRAWINGS

The present invention is explained in greater detail below on the basis of the exemplary embodiments, with reference to the drawings.

FIG. 1 shows a schematic illustration of an information system.

FIG. 2 shows a schematic illustration of a memory medium.

FIG. 3 shows a schematic illustration of a roadway segment as an edge having coordinate points and intermediate points.

FIG. 4 shows a second illustration of the roadway segment of FIG. 3.

FIG. 5 shows groups of attributes and associations with intermediate points.

### DETAILED DESCRIPTION OF THE INVENTION

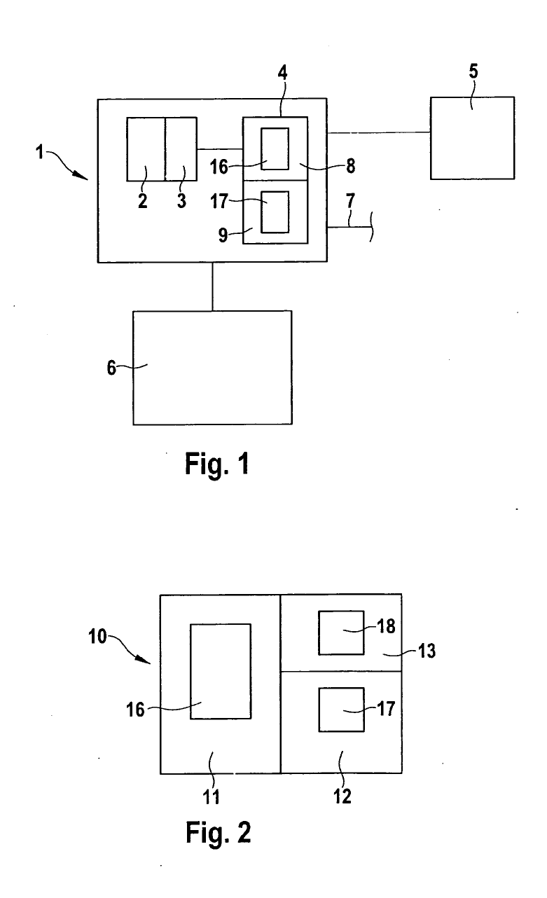

FIG. 1 shows a schematic illustration of an information system 1 which is designed as a navigation system, for example. Information system 1 has a computing unit 2 which has a working memory 3. Computing unit 2 is connected to a further memory 4. At least one control element 5, for example in the form of a keyboard or a touch-sensitive display, is also provided. Also provided is an output unit 6, for example in the form of an acoustic output such as a speaker and/or an optical output such as a display, which is connected to computing unit 2. In addition, independent of the selected specific embodiment, a signal output 7 may be provided which is connected to computing unit 2. Information may be output via signal output 7 which is taken into account, for example, by the motor vehicle, in particular by an internal combustion engine or a brake system. The signal of signal output 7 may also be used by accessory devices such as an audio device or a telephone, for example.

Memory 4 is subdivided into a first and a second memory area 8, 9. In first memory area 8, map data, for example, such as coordinate points, edges between the coordinate points, surface elements, or three-dimensional elements for imaging the actual circumstances of a roadway system, for example, are stored in a first data unit 16. Attributes in first data unit 16 may also be stored in first memory area 8. The term “data unit” is understood to mean, for example, a file or an addressable data object of a database, for example. The attributes represent characteristics of the map, in particular the roadways, i.e., of the edges, of the surface elements of the map or of the three-dimensional elements of the map. For example, an attribute may define a closed roadway, a given number of roadway lanes, a width of the roadway lane, lane-related directional information, or the permissibility of given vehicle classes or vehicle types. In addition, attributes may in turn be a function of other attributes. Thus, for example, a first attribute may designate a closed roadway, and a second attribute may define a specific period of time during which the roadway is closed.

An attribute may also be limited to a spatial region. The spatial limitation may be defined by coordinate points and/or by intermediate points, for example. For example, a no-passing zone or a speed limit may be valid for only a portion of a roadway between two intersections which are defined by coordinate points and/or intermediate points. In addition, the no-passing zone or the speed limit may be limited independently of the spatial structure of the roadway, i.e., of the coordinate points, with the aid of intermediate points. The intermediate points and the coordinate points are used to define a start and an end of the validity of the attributes.

The attributes may also include the following characteristics: the roadway width, the radius of curvature of a curve, the number of roadway lanes, the inclination of the roadway, and so forth.

In the specific embodiment illustrated, at least a portion of the intermediate points or all intermediate points is/are stored in a second data unit 17 in second memory area 9. If only a portion of the intermediate points in second data unit 17 is to be stored in second memory area 9, the other portion of the intermediate points in first data unit 16, for example, is stored in first memory area 8 or in another memory area of memory 4.

If the illustration of a travel route from Stuttgart to Hildesheim is now requested via control elements 5, computing unit 2 accesses only the map data of first memory area 8, transfers same, at least partially and temporarily, into working memory 3, and ascertains therefrom a graphical illustration of the travel route from Stuttgart to Hildesheim. For this purpose it is not necessary to access the second memory area in which the intermediate points are stored.

Instead of storing the map data in the first memory area, a first data unit may be used instead of a first memory area for storing the data. In addition, a second data unit may be used instead of second memory area 2 for storing the intermediate points.

Since the intermediate points are not needed for this requested information, computing unit 2 does not have to access second memory area 9, i.e., the second data unit, and is thus able to ascertain and output the requested information more quickly and reliably.

If in addition to the travel route from Stuttgart to Hildesheim, a request is now also made via control elements 5 for speed limits to be displayed and/or taken into account, computing unit 2 must then also access the intermediate points which spatially define the speed limits. In the illustrated exemplary embodiment, these intermediate points are stored in a second data unit in second memory area 9. Thus, it is necessary to also access second memory area 9 and the second data unit, and to read the intermediate points into working memory 3.

As a result of the advantageous substructuring of the data, it is possible to limit the level of computing effort, the level of effort for writing and reading, and the memory requirements for a large number of information items to be ascertained.

Depending on the selected specific embodiment, computing unit 2 may determine the frequency of information, in particular types of information, and store the intermediate points and/or attributes and/or map elements in such a way that less frequently needed intermediate points, attributes, and/or map elements are stored in second memory area 9. Learning is thus provided for the system, which improves the data structure by self-learning so that on average, less data must be processed.

FIG. 2 shows a schematic illustration of a memory medium in the form of a data memory 10, for example a hard drive memory or a CD or a DVD, which is subdivided into three memory areas. In a schematic illustration, data memory 10 has a first, a second, and a third data memory area 11, 12, 13, respectively. In a first data unit 16, for example map data such as coordinate points, edges, surface elements, or three-dimensional elements for imaging the actual circumstances, for example, are stored in first data memory area 11. Attributes for the map elements may also be stored in first data memory area 11. Intermediate points may also be stored in first data memory area 11.

In a second data unit 17, at least a portion of the intermediate points is stored in second data memory area 12. In a third data unit 18, another portion of the intermediate points and/or a portion of the attributes may be stored in third data memory area 13.

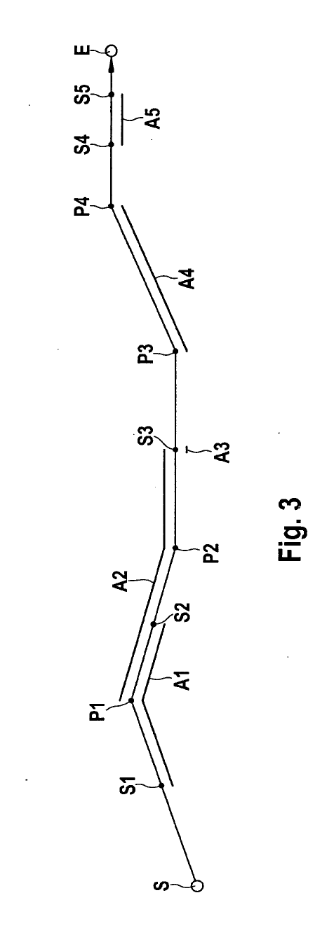

FIG. 3 shows a schematic graphical illustration of the association of attributes A1, A2, A3, A4, A5 with roadway segments. Of the stored roadway system, only one segment, from a start point S to an end point E, is illustrated. The segment is represented, beginning at start point S, with the aid of coordinate points P in the form of a polygonal line, each of the segment sections between the coordinate points being provided in the form of straight lines. Thus, beginning at start point S, the segment extends to first coordinate point P1, to second coordinate point P2, to third coordinate point P3, to fourth coordinate point P4, and to end point E.

In addition to coordinate points P1 through P4, intermediate points which are situated between coordinate points are also stored. For example, a first intermediate point S1 is provided between start point S and first coordinate point P1, a second intermediate point S2 is provided between first coordinate point P1 and second coordinate point P2, a third intermediate point S3 is provided between second coordinate point P2 and third coordinate point P3, and a fourth and fifth intermediate point S4 and S5 are provided between fourth coordinate point P4 and end point E.

In addition, the validity ranges of attributes A1, A2, A3, A4, A5 are graphically illustrated in the form of bars. In the specific embodiment illustrated, a first attribute A1 is valid from first intermediate point S1 to second intermediate point S2. A second attribute A2 is valid from first coordinate point P1 to third intermediate point S3. A third attribute A3 is valid only at point S3. A fourth attribute A4 is valid from third coordinate point P3 to fourth coordinate point P4. A fifth attribute A5 is valid from fourth intermediate point S4 to fifth intermediate point S5. It is thus clear that the validity ranges of the attributes may be defined both by coordinate points alone and by intermediate points alone, as well as by one intermediate point and one coordinate point. In the exemplary embodiment illustrated, for example the first, the second, the third, the fourth, and the fifth intermediate point S1, S2, S3, S4, S5, respectively, may be stored in second memory area 9 since these points are not needed for the strictly geographical representation of the segment, but, rather, are needed only for the validity range of the first, the third, or the fifth attribute A1, A3, A5, respectively.

For example, first attribute A1 and fifth attribute A5 may represent areas prohibited for trucks; this information is not actually needed for a standard passenger vehicle, and therefore these intermediate points are not actually needed. In addition, third intermediate point S3 may be stored in second memory area 9 or in first memory area 8, depending on the type of second attribute A2. For example, if second attribute A2 represents one-way roadway information for a roadway lane, this information is needed quite often for route planning, so that third intermediate point S3 should also be stored in first memory area 8. However, if second attribute A2 represents a speed limit which is limited for a short period of time, third intermediate point S3 may also be stored in second memory area 9 since this intermediate point is seldom needed.

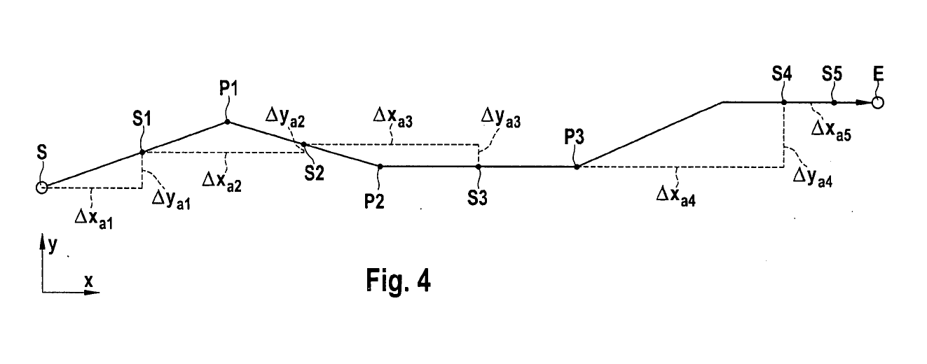

FIG. 4 shows the same segment section as FIG. 3, except that the position of the intermediate points is stored using differential coding. First intermediate point S1 is stored using difference values in the x and y directions in relation to start point S. Thus, for first intermediate point S1 a first difference value on the x axis and a second difference value Δyₐ₁ along the y axis are stored in relation to the starting value. For second intermediate point S2, difference values are in turn stored in relation to first intermediate point S1. Thus, for second intermediate point S2 difference value Δxₐ₂ along the x axis and a difference value Δyₐ₂ along the y axis in relation to first intermediate point S1 are stored. Similarly, difference values for third intermediate point S3 in relation to second intermediate point S2 are stored for the x axis and y axis. Furthermore, similar difference values for fourth intermediate point S4 in relation to third intermediate point S3 are stored. Likewise, similar difference values along the x axis and y axis for fifth intermediate point S5 in relation to fourth intermediate point S4 are stored.

The memory requirements are reduced by using difference values. With the aid of a simple coordinate comparison of coordinate points and intermediate points, it is possible to determine whether, for example, first intermediate point S1 is situated between start point S of the roadway segment and first coordinate point P1. For this purpose it is necessary only to compare the values in relation to one axis (x or y). Only when the coordinates are the same is it necessary to compare the coordinates on the respective other axis (y, x). Thus, a correct sequence of coordinate points and intermediate points along the roadway segment may be ascertained from the separate memory areas, i.e., the separate data units, with little complexity. This simple ascertainment is possible since the roadway segments are always linear between coordinate points. The data units are structured in the form of lists, for example.

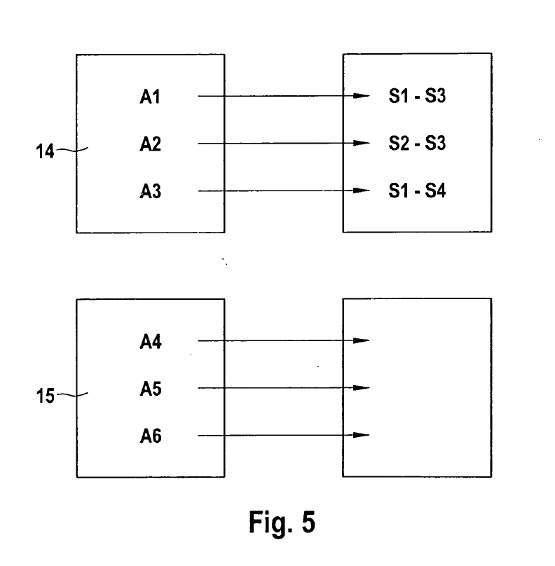

FIG. 5 shows a schematic illustration of a first and a second group 14, 15 of attributes. First group 14 has a first attribute A1, a second attribute A2, and a third attribute A3. The first attribute is defined in the spatial validity range by first intermediate point S1 and third intermediate point S3. Second attribute A2 is defined in the validity range by second intermediate point S2 and third intermediate point S3. Third attribute A3 is defined in the validity range by first intermediate point S1 and fourth intermediate point S4.

Second group 15 has a fourth, a fifth, and a sixth attribute A4, A5, A6, respectively, which are defined in the validity range by corresponding associations of intermediate points and/or coordinate points.

The first and the second group are defined, for example, in such a way that the attributes of first group 14 are needed twice as often as the attributes of second group 15. Thus, for example, the attributes of second group 15 and the intermediate points which are needed only for second group 15 are stored in second memory area 9. In this way the data volume may be reduced by an advantageous structuring of the data units and the memory areas for the intermediate points and the attributes.

The output signal which is output at signal output 7 by information system 1 may be used, for example, for controlling the internal combustion engine and/or for controlling the brakes and/or for a system for power recovery.

1-10. (canceled)

11. A method for operating a navigation system for a motor vehicle, the navigation system having a memory and a computing unit, the method comprising:
providing map data in the memory, wherein the map data includes map elements, attributes representing characteristics of the map elements, edges, coordinate points defining geographical positions and shapes of the edges, and intermediate points defining geographical points of the edges, wherein the intermediate points further define sections of edges in which an attribute is valid; and
ascertaining by the computing unit at least one information item on the basis of the edges, the coordinate points, the intermediate points, and the attributes; and
outputting by the computing unit the at least one information item;
wherein at least a portion of the intermediate points is stored in a different memory area of the memory than the coordinate points.

12. The method as recited in claim 11, wherein, depending on the information to be ascertained, the computing unit accesses a first memory area of the memory and does not access a second memory area of the memory, wherein the coordinate points are stored in the first memory area and the intermediate points are stored in the second memory area.

13. The method as recited in claim 12, wherein the map elements and the attributes are stored in multiple memory areas of the memory.

14. The method as recited in claim 12, wherein a difference value is associated with each intermediate point, wherein the difference value defines the position of the associated intermediate point in relation to one of another intermediate point or coordinate point.

15. The method as recited in claim 13, wherein the attributes are subdivided into multiple groups, and wherein at least a portion of the intermediate points associated with the multiple groups of attributes are stored in multiple memory areas of the memory.

16. The method as recited in claim 12, wherein the map elements and the coordinate points are stored in the first memory area of the memory.

17. A navigation system for a motor vehicle, comprising:
a computing unit; and
a memory storing map data, wherein the map data includes map elements, attributes representing characteristics of the map elements, edges, coordinate points defining geographical positions and shapes of the edges, and intermediate points defining geographical points of the edges, wherein the intermediate points further define sections of edges in which an attribute is valid;
wherein the computing unit is configured to ascertain and output at least one information item on the basis of the edges, the coordinate points, the intermediate points, and the attributes; and
wherein at least a portion of the intermediate points is stored in a different memory area of the memory than the coordinate points.

18. The information system as recited in claim 17, wherein, depending on the information to be ascertained, the computing unit accesses a first memory area of the memory and does not access a second memory area of the memory, wherein the coordinate points are stored in the first memory area and the intermediate points are stored in the second memory area.

19. The information system as recited in claim 18, wherein the map elements and the attributes are stored in multiple memory areas of the memory.

20. A computer-readable data storage medium for an information system having a computer unit, comprising:
memory areas configured to store map data, wherein the map data includes map elements, attributes representing characteristics of the map elements, edges, coordinate points defining geographical positions and shapes of the edges, and intermediate points defining geographical points of the edges, wherein the intermediate points further define sections of edges in which an attribute is valid;
wherein at least one information item is ascertained by the computing unit on the basis of the edges, the coordinate points, the intermediate points, and the attributes; and
wherein at least a portion of the intermediate points is stored in a different memory area than the coordinate points.
